(19) United States
(12) Patent Application Publication
(10) Pub. No.: US 2009/0282344 A1
(43) Pub. Date: Nov. 12, 2009

(54) Mobile device capable of selective mobile browsing and control method thereof

(75) Inventor: Young Jin Kim, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/386,467

(22) Filed: Apr. 17, 2009

(30) Foreign Application Priority Data
May 6, 2008 (KR) 10-2008-0041800

(51) Int. Cl. G06F 3/00

(52) U.S. Cl. 715/744

(57) ABSTRACT

A mobile device and a related control method allow a selective mobile browsing at access to web pages through an automatic selection of a web page display mode depending on history information, content types or URL information. Upon receipt of a request for access to a specific web page, a control unit checks display mode selection information about the requested web page. Then the control unit selects one of a plurality of display modes according to the display mode selection information. The selected display mode is suitable for the requested web page. Additionally, the control unit controls a display unit to display the web page in the selected display mode.

### CROSS-REFERENCE TO RELATED APPLICATION(S) AND CLAIM OF PRIORITY

The present application claims priority to an application entitled “MOBILE DEVICE CAPABLE OF SELECTIVE MOBILE BROWSING AND CONTROL METHOD THEREOF” filed in the Korean Intellectual Property Office on May 6, 2008 and assigned Serial No. 10-2008-0041800, the contents of which are incorporated herein by reference.

### TECHNICAL FIELD OF THE INVENTION

The present invention relates generally to mobile browsing technology and, more particularly, to a mobile device for allowing an automatic selection of a web page display mode depending on history information, content types or uniform resource locator information and a related control method.

### BACKGROUND OF THE INVENTION

In the era of digital convergence, a mobile device has developed into a multimedia device that can provide not only an existing voice call service but also various additional services including an electronic diary, game functions and schedule management functions. A mobile device supporting a radio data communication service is a typical example of such a multimedia device.

A radio data communication service refers to a service capable of wirelessly transmitting and receiving text and image data through a mobile device. By using this service, a user of a mobile device can search traffic information, stock information, and the like. Furthermore, a mobile device equipped with a mobile browser can provide an internet search service as well. This mobile browser today can allow a full browsing service similar in environment to a normal internet service using a personal computer.

A mobile device with relatively smaller resolution, however, has difficulty displaying a web page with relatively greater resolution on the mobile device screen. Therefore, a user can see only a part of the entire web page and, often, must scroll the web page, moving vertically or horizontally across the screen. In order to reduce this inconvenience, a technique to optimize a web page for the resolution of a mobile device has been proposed in the art. Unfortunately, this conventional technique has the following drawback. A predefined display mode to optimize a specific web page is not always suitable for all web pages. Therefore, whenever a user has access to web pages, the user should select manually a display mode suitable for a current web page.

### SUMMARY OF THE INVENTION

To address the above-discussed deficiencies of the prior art, it is a primary aspect of the present invention to address the above-mentioned problems and/or disadvantages and to provide at least the advantages described below. Accordingly, an aspect of the present invention provides a mobile device and a method that may allow an automatic selection of a web page display mode depending on history information, content types or URL information when web pages are accessed.

According to an aspect of the present invention, a method for controlling selective mobile browsing comprises: receiving a request for access to a web page; checking display mode selection information corresponding to the requested web page; selecting one of a plurality of display modes according to the display mode selection information, the selected display mode being suitable for the requested web page; and controlling a display unit to display the web page in the selected display mode.

According to another aspect of the present invention, a mobile device for selective mobile browsing comprises: an RF unit capable of transmitting a request for access to a web page, and receiving the requested web page; a control unit capable of checking display mode selection information about the requested web page, and selecting one of a plurality of display modes according to the display mode selection information, the selected display mode being suitable for the requested web page; and a display unit capable of displaying the web page in the selected display mode under the control of the control unit.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “control unit” means any device, system or part thereof that controls at least one operation, such a device may be implemented in hardware, firmware or software, or some combination of at least two of the same. It should be noted that the functionality associated with any particular control unit may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic view illustrating a wireless internet service system in accordance with an exemplary embodiment of the present invention;

FIG. 2 is a block diagram illustrating a configuration of a mobile device in accordance with an exemplary embodiment of the present invention;

FIGS. 3A and 3B are example views illustrating web page display modes in accordance with an exemplary embodiment of the present invention;

FIG. 4 is a flow diagram illustrating a mobile browsing control method in accordance with an exemplary embodiment of the present invention; and

FIG. 5 is a flow diagram illustrating a mobile browsing control method in accordance with another exemplary embodiment of the present invention.

### DETAILED DESCRIPTION OF THE INVENTION

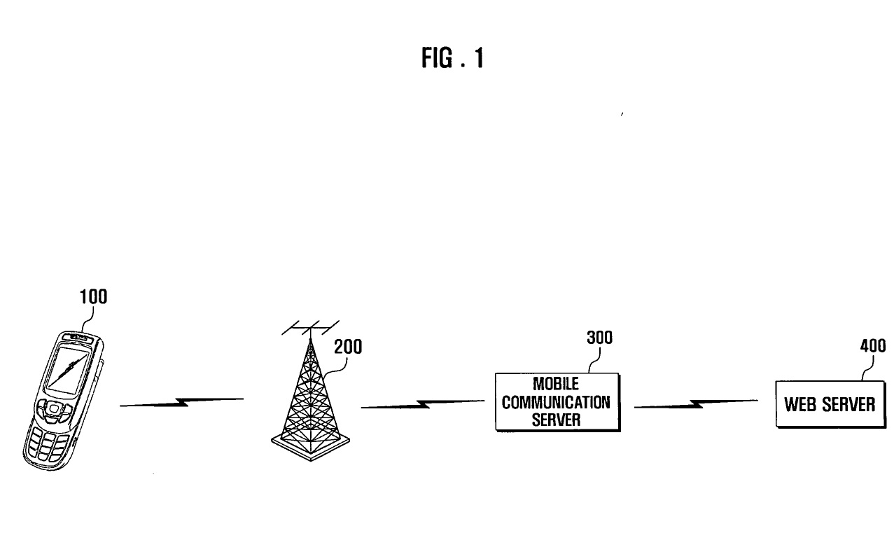

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

Furthermore, well known or widely used techniques, elements, structures, and processes may not be described or illustrated in detail to avoid obscuring the essence of the present invention.

Mobile devices, also known as portable devices, handheld devices, etc., of the present invention are devices capable of a wireless internet and allowing a full browsing. These devices may include mobile communication devices, digital broadcast devices, mobile computers, Personal Digital Assistants (PDA), smart phones, International Mobile Telecommunication 2000 (IMT-2000) devices, Wideband Code Division Multiple Access (WCDMA) devices, Global System for Mobile communications (GSM) devices, and Universal Mobile Telecommunication Service (UMTS) devices.

Among terminologies used herein, a mobile browser refers to a web browser designed for use on a mobile device, and mobile browsing refers to a technique to display web pages (usually including web documents and linked objects) by using a mobile browser.

A first display mode refers to a mode of displaying a web page optimized for the resolution of a mobile device, and a second display mode refers to a mode of displaying a web page as its resolution remains unchanged. The second display mode may be also referred to as a full browsing mode.

Furthermore, display mode selection information is a basis used to select one of the first and second display modes. This display mode selection information may include history information, content types and uniform resource locator (URL) information.

FIG. 1 shows, in a schematic view, a wireless internet service system in accordance with an exemplary embodiment of the present invention.

Referring to FIG. 1, the wireless internet service system includes a mobile device 100, a base station 200, a mobile communication server 300, and a web server 400.

The mobile device 100 is a device or a terminal that allows a wireless communication. Particularly, the mobile device 100 is equipped with a mobile browser and enables a full browsing service. Additionally, the mobile device 100 can automatically select a web page display mode depending upon the display mode selection information at access to a web page.

The base station 200 is a radio receiver/transmitter that serves as the hub of the local wireless network. Specifically, the base station 200 enables the mobile device 100 to have access to the web server 400 through the mobile communication server 300 and thereby to use a wireless internet service.

The mobile communication server 300 is a server of a mobile network operator that provides services for subscribers of the mobile device 100. For example, the mobile communication server 300 provides a variety of content services such as mobile games, caller ID display services, coloring services or ring tone services. Specifically, the mobile communication server 300, together with the web server 400, provides a wireless internet service to the mobile device 100. The mobile communication server 300 may act as a gateway that allows or controls access to another communication network with an unequal protocol.

The web server 400 is an internet service provider that has in general a content provider (CP). Specifically, the web server 400 accepts requests from clients and serves them responses along with contents that usually are web pages including web documents and linked objects (images and the like).

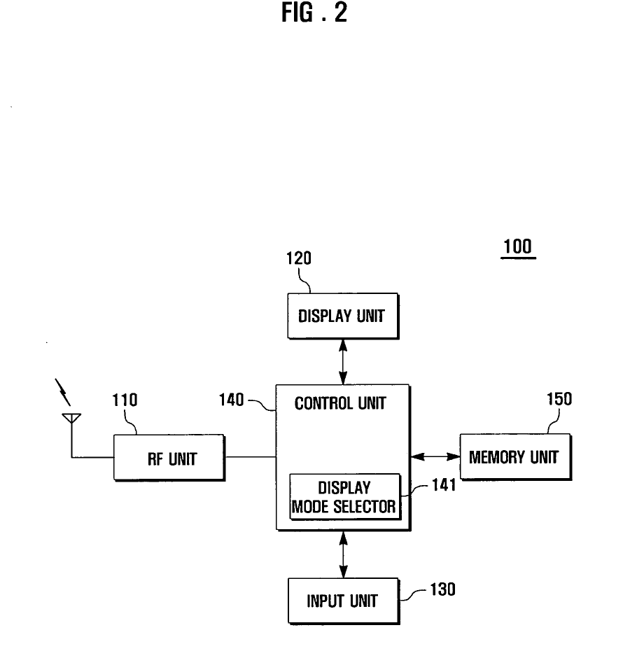

FIG. 2 shows, in a block diagram, a configuration of a mobile device 100 in accordance with an exemplary embodiment of the present invention.

Referring to FIG. 2, the mobile device 100 includes a radio frequency (RF) unit 110, a display unit 120, an input unit 130, a control unit 140, and a memory unit 150.

The RF unit 110 performs a wireless communication function of the mobile device 100. Specifically, the RF unit 110 includes an RF transmitter that up-converts a frequency of a signal to be transmitted and amplifies the signal, an RF receiver that down-converts a frequency of a received signal and low-noise amplifies the signal, and a duplexer that isolates the reception frequency from the transmission frequency. Additionally, the RF unit 110 has access to the web server 400 through the mobile communication server 300 under the control of the control unit 140, thereby transmitting and receiving data. For example, the RF unit 110 transmits a signal of a web page access request to the web server 400 and receives the requested web page from the web server 400.

The display unit 120 displays various kinds of graphical information inputted by a user or offered to a user. For example, the display unit 120 provides graphical user interfaces such as a standby screen, hierarchical menu screens, a call screen, a message writing screen, and the like. The display unit 120 may employ a liquid crystal display (LCD) device or other alternative display devices. Furthermore, the display unit 120 may be a touch-screen display that performs also parts or all of functions of the input unit. In particular, the display unit 120 displays a web page, received through the RF unit 110, in the first or the second display mode depending on display mode selection information. As discussed above, in the first display mode a web page is optimized for the resolution of a mobile device, and in the second display mode a web page is displayed as its resolution remains unchanged.

The input unit 130 includes a number of alphanumeric keys and function keys arranged for efficient data entry. The function keys may have navigation keys, side keys, shortcut keys, and other kinds of special keys. The input unit 130 creates key input signals related to user's setting or a function control of the mobile device 100 and then sends them to the control unit 140. For example, such key input signals may include URL input for web page access or change of web page display modes.

The control unit 140 controls signal flows between function blocks in the mobile device 100, and provides control signals required for operation of the mobile device 100. Particularly, at access to a web page, the control unit 140 selects a web page display mode depending on display mode selection information. To execute the above function, the control unit 140 may include a display mode selector 141.

The display mode selector 141 selects a web page display mode according to display mode selection information, which may include history information, content types or uniform resource locator (URL) information.

Specifically, history information is mapping data between web sites and display modes, and stored in the memory unit 150. At access to a specific web page, the display mode selector 141 checks such history information related to the web page and selects a display mode suitable for the web page. Further description about history information will be made later.

Among the above-discussed display mode selection information, content types mean markup languages for web pages. Wireless Markup Language (WML) and Hyper-Text Markup Language (HTML) are well-known examples of content types. WML has been developed to be used in wireless internet environment and is available for mobile devices with a small screen, a limited memory capacity and a narrow bandwidth. HTML is one of many representative markup languages for web pages and one of the most used in the Internet.

When a web page is made in the form of WML suitable for the mobile device, the display mode selector 141 selects the first display mode. Conversely, when a web page is made in the form of HTML, the display mode selector 141 selects the second display mode. Specifically, when accessing a specific web page, the mobile device 100 sends a request header, including the type of a mobile browser, cookies, a web page address, and the like, to the web server 400. Then the web server 400 sends a response header, including status information of a requested web page, date information containing time, the type of a web server, the content type of a requested web page, and the like, to the mobile device 100. When receiving the response header, the display mode selector 141 checks the content type included in the response header and selects one of the first display mode and the second display mode.

In the above description, WML and HTML are exemplary only and not to be considered as a limitation of the present invention. Other content types, such as XHTML and MHTML, may be alternatively employed for the present invention.

Among the above-discussed display mode selection information, URL information often is used as an address format of a web page. The display mode selector 141 checks URL information of a web page and selects the second display mode when the address format of a web page is based on the World Wide Web (i.e., HTTP://www). Conversely, when the address format is not based on the World Wide Web (WWW), the display mode selector 141 selects the first display mode.

The memory unit 150 stores a variety of application programs required for operation of the mobile device 100, and may include a program region and a data region.

The program region stores an operating system (OS) for booting the mobile device 100, an application program required for playing multimedia contents, and other application programs for performing optional functions such as a camera, an audio replay, an image or video replay, and the like. Particularly, the program region may store a mobile browser that may contain a plurality of display modes. The mobile browser allows a web page to be displayed in one of the plurality of display modes depending on display mode selection information. For the above, the mobile browser may have a web page conversion function whereby a web page is optimized for the resolution of the mobile device. This conversion function may be embedded in the control unit itself.

The data region stores data created in use of the mobile device 100. Specifically, the data region may store phonebook data, audio data, contents, metadata related to contents, and any other user-related data. Particularly, the data region may store history information among display mode selection information. History information includes addresses of web pages that a user has accessed and display modes of these accessed web pages.

Table 1 shows an example of history information stored in the memory unit 150.

TABLE 1

| Address | Display Mode | Time |
|---|---|---|
| www.naver.com | 1 | 03122008 |
| www.yahoo.com | 2 | 03132008 |
| www.google.co.kr | 2 | 03152008 |
| www.amazone.com | 1 | 04122008 |

As shown in Table 1, history information may have a web page address, a web page display mode, and the last access time. If there is a request for access to a specific web page (e.g., www.naver.com), the display mode selector 141 ascertains history information. Thereby the display mode selector 141 finds a display mode (e.g., the first display mode) corresponding to the requested web page and selects the found display mode.

This history information is updated whenever web pages are accessed. Furthermore, if a user who is viewing a specific web page changes a display mode for the current web page, the changed display mode is newly stored in a display mode of that page. However, Table 1 is exemplary only and not to be considered as a limitation of the present invention. History information may further include any other information.

Although not illustrated, the mobile device 100 may further selectively include well-known elements such as a camera module, a broadcast receiving module, an audio processing module, external connection terminals, recharging terminals, an MP3 module and any other equivalents.

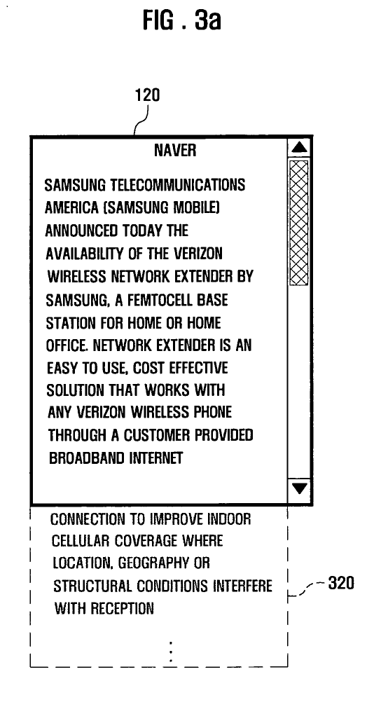

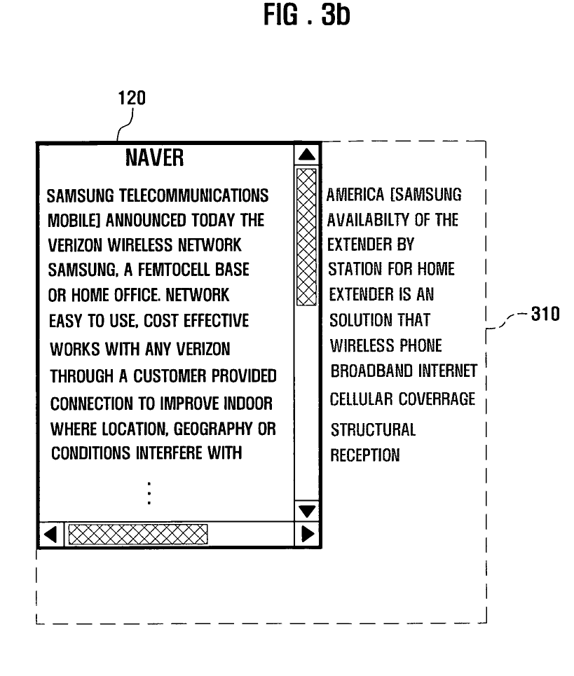

FIGS. 3A and 3B are example views that illustrate web page display modes in accordance with an exemplary embodiment of the present invention. Specifically, FIG. 3A shows the first display mode, and FIG. 3B shows the second display mode.

Referring first to FIG. 3A, in the first display mode a web page 320 is optimized for the resolution of the mobile device. That is, the width of this web page 320 is fitted to that of the display unit 120. A user can therefore view the entire web page through a vertical scroll only. A web page conversion function makes it possible to optimize a web page. As discussed above, the mobile browser or the control unit may have such a web page conversion function.

Referring to FIG. 3B, in the second display mode a web page 310 is displayed as it is. That is, this web page 310 maintains the original resolution, which is usually greater than that of the display unit 120. So, the display unit 120 can display lengthwise and widthwise only a portion of the entire web page 310, and a user has to scroll the page 310 vertically or horizontally.

As discussed above, depending on display mode selection information, the display mode selector 141 automatically selects a display mode for a web page to be viewed. However, the selected display mode optionally may be changed by a user's input. Views shown in FIGS. 3A and 3B are for example purposes only and not to be considered as a limitation of the present invention. Although the display unit 120 in FIGS. 3A and 3B displays a scroll bar for a vertical or horizontal scroll, any other alternative graphical indicator may be used for indicating a move of a page. Additionally, the display unit 120 may overlap a thumbnail view with a reduced size on a part of the displayed page so as to indicate the location of a currently displayed part in the entire page.

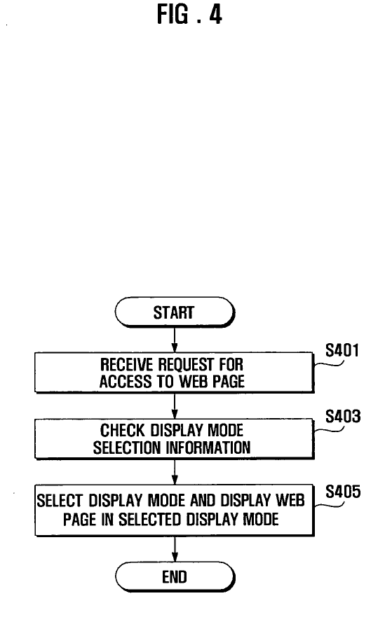

FIG. 4 is a flow diagram that illustrates a mobile browsing control method in accordance with an exemplary embodiment of the present invention.

Referring to FIG. 4 together with FIG. 1, the input unit 130 receives a user's request for access to a specific web page (step S401). Here, a user's request may be inputted through a shortcut key press, an access menu selection, a direct input of URL, or any other input process or method.

On receipt of a user's request for web page access, the control unit 140 checks display mode selection information (step S403). As discussed above, the display mode selection information may include history information, content types or URL information.

Then, depending on the display mode selection information, the control unit 140 selects a display mode suitable for the requested web page, and controls the display unit 120 to display the web page in the selected display mode (step S405).

Here, the selected display mode may be one of the first display mode and the second display mode.

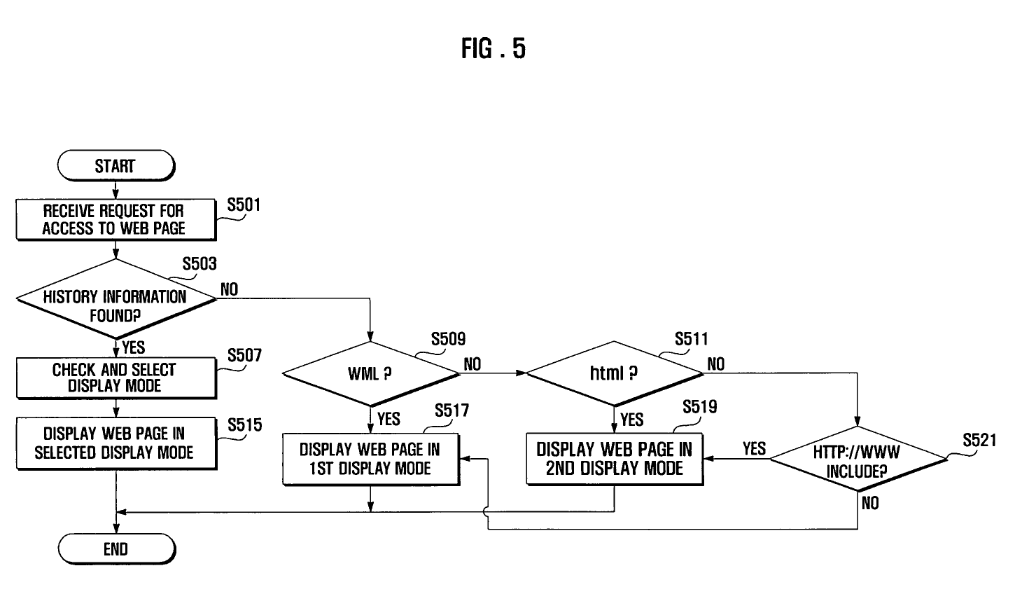

FIG. 5 is a flow diagram that illustrates a mobile browsing control method in accordance with another exemplary embodiment of the present invention.

Referring to FIG. 5 together with FIGS. 1 and 2, the input unit 130 receives a user's request for access to a specific web page (step S501) in a manner similar to the aforesaid step S401.

Then, on receipt of a user's request for web page access, the control unit 140 sends a request header to the web server 400 through the RF unit 110. As discussed above, such a request header may include the content type of a mobile browser, cookies, a web page address, and the like.

Then the control unit 140 receives a response header including the content type of the requested web page from the web server 400. As discussed above, such a response header may further include status information of the requested web page, date information containing time, the type of a web server, and the like.

Next, the display mode selector 141 of the control unit 140 determines whether the requested page is found in history information stored in the memory unit 150 (step S503). As discussed above, history information is a mapping data between web page addresses and display modes.

If history information about the requested page is found, the display mode selector 141 of the control unit 140 checks and selects the display mode corresponding to the requested web page (step S507). Then, the control unit 140 controls the display unit 120 to display the requested web page in the selected display mode (step S515). Furthermore, the control unit 140 may update history information during or after the step S515. Particularly, if a user changes a display mode of a specific web page, the control unit 140 had better update history information to substitute a new display mode.

If history information about the requested web page is not found in the aforesaid step S503, the display mode selector 141 of the control unit 140 further checks the content type in the response header received from the web server 400. Specifically, the display mode selector 141 determines whether the content type of the requested web page is WML (step S509). If the content type is WML, the display mode selector 141 selects the first display mode, and therefore the control unit 140 controls the display unit 120 to display the requested web page in the first display mode (step S517).

If the content type is not WML in the aforesaid step S509, the display mode selector 141 further determines whether the content type is HTML (step S511). If the content type is HTML, the display mode selector 141 selects the second display mode, and therefore the control unit 140 controls the display unit 120 to display the requested web page in the second display mode (step S519).

If the content type is not HTML in the aforesaid step S511, the display mode selector 141 further checks URL information. That is, the display mode selector 141 determines whether URL information includes the address format based on the World Wide Web (i.e., HTTP://www) (step S521). If URL information includes the World Wide Web format, the aforesaid step S519 is performed. That is, the display mode selector 141 selects the second display mode, and the control unit 140 controls the display unit 120 to display the requested web page in the second display mode. Unless URL information includes the World Wide Web format, the aforesaid step S517 is performed. That is, the display mode selector 141 selects the first display mode, and the control unit 140 controls the display unit 120 to display the requested web page in the first display mode.

As fully described heretofore, the mobile device according to the present invention allows a selective mobile browsing at access to web pages through an automatic selection of a web page display mode depending on history information, content types or URL information.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for controlling a selective mobile browsing, the method comprising:
receiving a request for access to a web page;
checking display mode selection information corresponding to the requested web page;
selecting one of a plurality of display modes according to the display mode selection information, the selected display mode being suitable for the requested web page; and
controlling a display unit to display the web page in the selected display mode.

2. The method of claim 1, wherein the plurality of display modes includes a first display mode in which the web page is optimized for a resolution of the display unit, and a second display mode in which a resolution of the web page remains unchanged.

3. The method of claim 2, wherein the display mode selection information includes history information, a content type, and uniform resource locator (URL) information, the history information being a mapping data between a web page address and the display mode, the content type being a markup language for the web page, and the URL information being an address format of the web page.

4. The method of claim 3, further comprising:
updating the history information during or after the controlling of the display unit to display the web page.

5. The method of claim 3, wherein the checking of the display mode selection information includes determining whether the requested web page is found in the history information.

6. The method of claim 5, wherein the checking of the display mode selection information further includes, if the history information about the requested page is not found, determining whether the content type of the requested web page is WML or HTML.

7. The method of claim 6, wherein the selecting of the display mode includes selecting the first display mode if the content type is WML, and selecting the second display mode if the content type is HTML.

8. The method of claim 7, wherein the checking of the display mode selection information further includes, if the content type is neither WML nor HTML, determining whether the URL information includes an address format based on the World Wide Web.

9. The method of claim 8, wherein the selecting of the display mode includes selecting the second display mode if the URL information includes the World Wide Web format, and selecting the first display mode unless the URL information includes the World Wide Web format.

10. A mobile device for a selective mobile browsing, the device comprising:
an RF unit capable of transmitting a request for access to a web page and receiving the requested web page;
a control unit capable of checking display mode selection information about the requested web page and selecting one of a plurality of display modes according to the display mode selection information, the selected display mode being suitable for the requested web page; and
a display unit capable of displaying the web page in the selected display mode under the control of the control unit.

11. The device of claim 10, wherein the plurality of display modes includes a first display mode in which the web page is optimized for a resolution of the display unit, and a second display mode in which a resolution of the web page remains unchanged.

12. The device of claim 11, wherein the display mode selection information includes history information, a content type, and uniform resource locator (URL) information, the history information being a mapping data between a web page address and the display mode, the content type being a markup language for the web page, and the URL information being an address format of the web page.

13. The device of claim 12, further comprising:
a memory unit capable of storing the history information.

14. The device of claim 12, wherein the control unit updates the history information during or after the display unit displays the web page.

15. The device of claim 12, wherein the control unit determines whether the requested web page is found in the history information.

16. The device of claim 15, wherein the control unit further determines, if the history information about the requested page is not found, whether the content type of the requested web page is WML or HTML, selects the first display mode if the content type is WML, and selects the second display mode if the content type is HTML.

17. The device of claim 16, wherein the control unit further determines, if the content type is neither WML nor HTML, whether the URL information includes an address format based on the World Wide Web, selects the second display mode if the URL information includes the World Wide Web format, and selects the first display mode unless the URL information includes the World Wide Web format.

18. The device of claim 10, wherein the control unit includes a display mode selector that automatically selects one of the plurality of display modes according to the display mode selection information.
